(19) United States
(12) Patent Application Publication
(10) Pub. No.: US 2015/0058094 A1
(43) Pub. Date: Feb. 26, 2015

(54) Assessing a Process Based on Process Drivers and Business Results

(71) Applicant: Sandeep Sharma, Bangalore (IN)

(72) Inventor: Sandeep Sharma, Bangalore (IN)

(21) Appl. No.: 14/465,946

(22) Filed: Aug. 22, 2014

(30) Foreign Application Priority Data
Aug. 23, 2013 (IN) 2763/MUM/2013

(51) Int. Cl. G06Q 10/06; H04L 12/26

(52) U.S. Cl. CPC G06Q 10/06393; H04L 43/04
USPC 705/7.39

(57) ABSTRACT

Systems and methods for assessing performance of a process are disclosed. In accordance to the method, one or more process drivers of the process and one or more business results achieved by the process are identified for a time frame. One or more driver scores for the one or more process drivers of the process are determined based on a rating scale. Further, one or more result scores for the one or more business results achieved by the process are determined based on one or more targets. In another act of the method, the process is assessed for the time frame using the one or more driver scores and one or more result scores.

### CROSS-REFERENCE TO RELATED APPLICATIONS

This application claims the benefit of Indian Patent Application No. 2763/MUM/2013, filed on Aug. 23, 2013, which is hereby incorporated by reference in its entirety.

### TECHNICAL FIELD

The present embodiments relate to methods and systems for assessing a process, and more particularly, to methods and systems for assessing performance of a process based on process drivers and business results.

### BACKGROUND

Stability and maturity of an organization primarily depends upon the processes being followed in the organization. A process includes a sequence of acts executed by a human or a system or by a combination of a human and a system to accomplish an objective. The process may be a business process like leave approval, claim settlement, travel request approval, etc.

There are various standards available for implementing all types of organizational processes. These standards are applicable to all kinds of industries, hence helpful in maintaining the processes consistent globally. Companies and/or institutions that own these standards issue certificates to the organizations that are able to successfully implement their process according to the standards. Most commonly known standardized certifications are ISO certifications like ISO 9001:2008, ISO 14001:2004, ANSI certification, etc. These certifications provide the customers, vendors or any third party, that the processes (such as design, manufacturing, production, purchasing, packaging, storage, shipping, customer service, etc.), of the organization are appropriately implemented, managed, and controlled.

The major drawback of the above mentioned standardized certifications is that these certifications are on organizational level. In other words, any organization may get these certifications when all the organizational processes are implemented according to the corresponding definitions given in the desired standard.

From the above description, it is evident that all the existing standards issue certifications on organizational level. There is no standard available that certifies any process of an organization individually without considering the other organizational processes. Hence, there is a need of method and system that may assess a process individually considering the corresponding process drivers of the process and business results achieved by the process.

### SUMMARY

It is therefore an object of the present embodiments to provide methods and systems for assessing the performance of a process based on process drivers and business results.

The scope of the present invention is defined solely by the appended claims and is not affected to any degree by the statements within this summary. The present embodiments may obviate one or more of the drawbacks or limitations in the related art.

In a first aspect, a method for assessing performance of a process during a time frame is disclosed. In accordance to the method, initially one or more process drivers of the process for the time frame and one or more business results achieved by the process for the time frame are identified. One or more driver scores for the one or more process drivers of the process are determined based on a rating scale. In another act, one or more result scores for the one or more business results achieved by the process are determined based on the comparison of the one or more business results with one or more targets corresponding to the business results. In another act of the method, the process is assessed for the time frame using the one or more driver scores and one or more result scores.

In accordance with the first aspect, the rating scale and the one or more targets are predefined for the time frame.

Also, in accordance with the first aspect, the one or more driver scores and the one or more result scores are plotted on a graph before assessing the process for the time frame.

Further, in accordance with the first aspect, a driver mean value from the one or more driver scores and a result mean value from the one or more result scores are determined.

Furthermore, in accordance with the first aspect, the one or more driver scores and the one or more result scores of the process are compared with one or more driver scores and one or more result scores of the process for another time frame.

In a second aspect, a system for assessing performance of a process is disclosed. The system includes a first identification module for identifying one or more process drivers related to the process for a time frame and a second identification module for identifying one or more business results related to the process for the time frame. The system also includes a first evaluation unit for determining one or more driver scores for the one or more process drivers of the process based on a rating scale and a second evaluation unit for determining one or more result scores for the one or more business results of the process based on a comparison of the one or more business results with one or more targets corresponding to the business results. In addition to this, the system also includes a processor for assessing the process for the time frame based on the one or more driver scores and one or more result scores.

In accordance with the second aspect, the system includes a memory unit for storing the rating scale and the one or more targets wherein the rating scale and the one or more targets are predefined for the time frame.

Further in accordance with the second aspect, the system includes a graph plotter for plotting the one or more driver scores and the one or more result scores on a graph.

Furthermore in accordance with the second aspect, the system also includes a comparator for comparing the one or more driver scores and the one or more result scores of the process for the time frame with one or more driver scores and one or more result scores of the process for another time frame.

Also, in accordance with the second aspect, the processor is configured to determine a driver mean value from the one or more driver scores and a result mean value from the one or more result scores for assessing the process.

Accordingly, the present embodiments provide systems and methods for assessing the performance of a process based on process drivers and business results.

### BRIEF DESCRIPTION OF THE DRAWINGS

FIG. 1 depicts a block diagram of an embodiment of a system for assessing performance of a process.

FIG. 2 depicts a flowchart for an embodiment of a method for assessing performance of a process.

### DETAILED DESCRIPTION

Various embodiments are described with reference to the drawings, wherein like reference numerals are used to refer to like elements throughout. In the following description, for purpose of explanation, details are set forth in order to provide a thorough understanding of one or more embodiments.

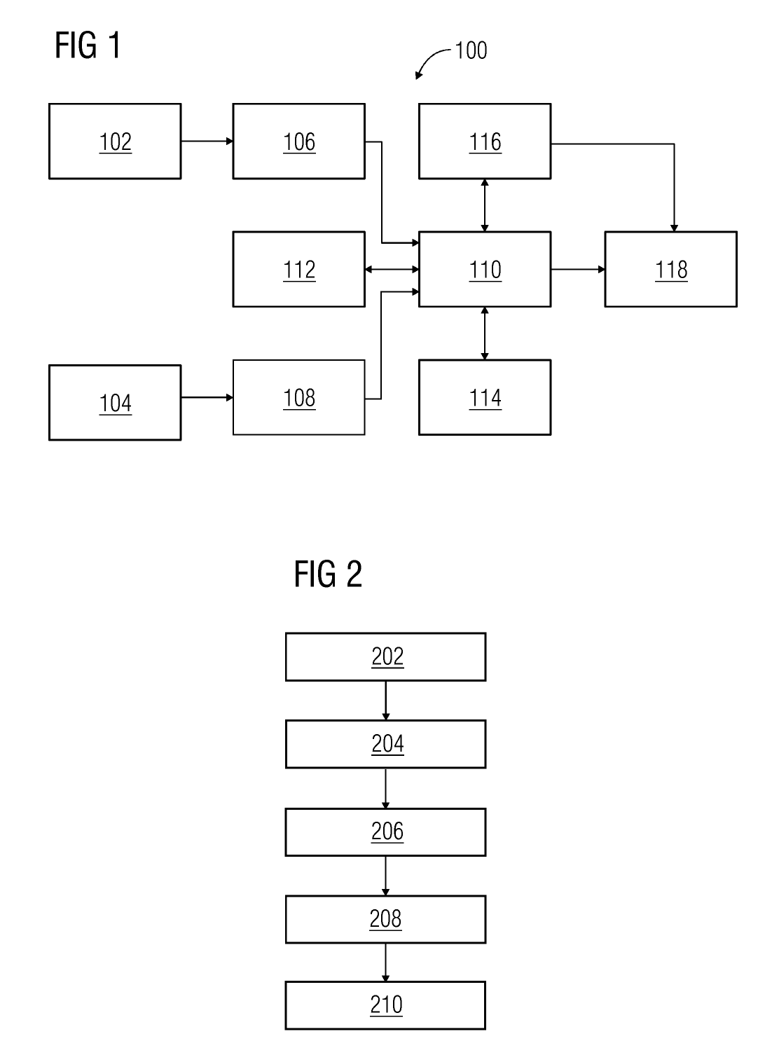

FIG. 1 illustrates a block diagram of an embodiment of a system 100 for assessing a performance of a process.

As depicted in FIG. 1, the system 100 for assessing the performance of a process uses process drivers and business results. The system 100 includes a first identification module 102, a second identification module 104, a first evaluation unit 106, a second evaluation unit 108, a processor 110 and a display 118. The system 100 also includes a memory unit 112, a comparator 114 and a graph plotter 116.

Process drivers for all the processes related to an organization are stored in the first identification module 102 depicted in FIG. 1. The organization may be any group including but not limited to a private firm, a government body, an institution, etc. The first identification module 102 identifies process drivers for a time frame of a process that needs to be assessed from the stored process drivers for all processes applied in the organization. The time frame may be any definite period of time like a financial year or a month or a quarter of a year etc. Essentially, the time frame is that period of time during which the process to be assessed is driven. The process drivers of the process that needs to be assessed will include, but not limited to, operation-level-agreement (OLA) management, benchmarking, quality initiative penetration, innovation quotient, and people skill maturity. The process drivers identified by the first identification unit 102 will be a measure of different assessing parameters of the process that need to be assessed. The assessing parameters are the parameters on which a process will be assessed. The assessing parameters of the process include, but are not limited to, operation excellence, standardization, and quality of service. The process drivers required to measure operation excellence of the process that need to be assessed will be OLA management, innovation quotient, and benchmarking. Similarly, the process drivers required to measure standardization of the process that need to be assessed will be OLA management and quality of service. The required process drivers for the assessing parameters recited here are for exemplary purposes and may vary on case to case basis.

The first identification module 102 identifies the process drivers related to the process that needs to be assessed and sends the identified process drivers to the first evaluation unit 106 for further processing. For example, an input for the first identification module 102 may be the process to be assessed or an identifier of that process, respectively. For example, each process applied in the organization may be identified by a unique ID. The ID of the process to be assessed may be fed to the first identification module 102 such that the first identification module 102 may identify the process drivers related to that process. Those process drivers are already stored in the first identification module 102.

All business results of the organization are stored in the second identification module 104 depicted in FIG. 1. The second identification unit 104 identifies the business results for the time frame of the process that need to be assessed from the stored business results of the organization. The business results of the process that need to be assessed will include, but not limited to, customer appreciation, savings generation, escalation management and attrition management. The business results identified by the second identification unit 104 will be a measure of the assessing parameters of the process that need to be assessed. The assessing parameters measured by the business results of the process includes, but not limited to, customer orientation, harmonization and cost effectiveness. The business results required to measure customer orientation of the process that need to be assessed will be customer appreciation and escalation management. Similarly, the business result required to measure cost effectiveness of the process that need to be assessed is savings generation. The required business results for the assessing parameters recited here are for exemplary purposes and may vary on case to case basis. Actually, the business results to be considered in the assessment of the process will depend on the type/nature of the process.

The second identification module 104 identifies the business results related to the process that needs to be assessed and sends the identified business results to the second evaluation unit 108 for further processing. For example, an input for the second identification module 104 may be the process to be assessed or an identifier of that process, respectively. As mentioned above, each process applied in the organization may be identified by a unique ID. The ID of the process to be assessed may be fed to the second identification module 104 such that the second identification module 104 may identify the business results related to that process. Those business results are already stored in the second identification module 104.

The first evaluation unit 106 receives the identified process drivers from the first identification module 102 as depicted in FIG. 1. The first evaluation unit 106 is in contact with the processor 110 and the memory unit 112 as depicted in FIG. 1. The first evaluation unit 106 determines driver scores for the identified process drivers received from the first identification unit 102, which are the process drivers of the process that need to be assessed. The first evaluation unit 106 determines the driver scores based on a rating scale stored in the memory unit 112. The driver scores are the numerical values for process drivers identified by the first identification module 102. In an exemplary embodiment, the rating scale stored in the memory unit 112 has ratings from 0 to 5 wherein rating 0 is the worst rating and rating 5 is the best rating. The first evaluation unit 106 gives driver score to the identified process drivers by using a mapping algorithm on the rating scale of 0 to 5 stored in memory unit 112. The mapping algorithm is an algorithm used for mapping a parameter on a pre-defined scale. The mapping algorithm is well known to a person ordinarily skilled in the art. In one embodiment, each driver score for all process drivers, e.g., not only for the process drivers relevant for the process to be assessed, but for process drivers for all processes in the organization that might be assessed, is defined by a user using an input mechanism attached with the first evaluation unit 106. The user may be, but not limited to, either an employee of the organization or an owner of the process or an external auditor. The first evaluation unit 106 evaluates the driver scores and sends them to the processor 110 as depicted in FIG. 1.

The second evaluation unit 108 receives the identified business results from the second identification module 104 as recited above. The second evaluation unit 108 is in contact with the processor 110 and the memory unit 112 as depicted in FIG. 1. The second evaluation unit 108 determines result scores for the identified business results received from the second identification unit 104, which are the business results of the process that needs to be assessed. The second evaluation unit 108 determines the result scores based on a comparison of the business results received from the second identification module 104 with targets that are stored in the memory unit 112. The targets are the business related goals, e.g., defined in the beginning of the time frame for all the processes of the organization and are needed to be achieved by the end of the time frame. The result scores are the numerical values for each business result identified by the second identification module 104. In an exemplary embodiment, the result scores are evaluated by the second evaluation unit 108 based on the comparison of the business results received from the second identification module 104 with the corresponding targets stored in the memory unit 112 using the similar approach as the driver scores are evaluated by the first evaluation unit 106 using the rating scale stored in the memory unit 112, as recited above. In one embodiment, the result scores are evaluated by the user using another input mechanism attached with the second evaluation unit 108. The second evaluation unit 108 evaluates the result scores and sends them to the processor 110 as depicted in FIG. 1.

As may be seen from the above, the memory unit 112 stores both the rating scales for all driver scores for all process drivers as well as all business related goals and targets, respectively.

The processor 110 receives the driver scores from the first evaluation unit 106 and the result scores from the second evaluation unit 108, as recited above. Also, the processor 110 is connected to the memory unit 112, the comparator 114, the graph plotter 116 and the display 118 as depicted in FIG. 1. The processor 110 calculates a driver mean value from the received driver scores from the first evaluation unit 106 for the identified process drivers, e.g., the process drivers identified by the first identification unit 102, for the process that needs to be assessed. Similarly, the processor 110 calculates a result mean value from the received result scores from the second evaluation unit 108 for the identified business results, e.g., the business results identified by the second identification unit 104, of the process that needs to be assessed. The driver mean value is an average of received driver scores and the result mean value is an average of received result scores. The processor 110 is capable of displaying the driver mean value and the result mean value on the display 118. The processor 110 is also capable of plotting the driver mean value and the result mean value of the process that needs to be assessed, on a graph using the graph plotter 116 and displaying the graph on the display 118. In one embodiment, the processor 110 is capable of plotting the driver mean value and the result mean value on a graph without using the graph plotter 116.

For example, the driver mean value may be the average value of the driver scores received from the first evaluation unit 106. As described above, the rating scales might have ratings from 0 to 5 wherein rating 0 is the worst rating and rating 5 is the best rating. The driver scores and, therewith, the driver mean value might also have values between 0 and 5. The same approach may be applicable for the result scores and the corresponding result mean value. Thus, higher values of the driver mean value and of the result mean value indicate a higher effectiveness of the process to be assessed.

In another exemplary embodiment the driver scores and the result scores of the process, that needs to be assessed, are plotted on a grid graph by plotting the driver scores on the x-axis and the result scores on the y-axis of the grid graph. As mentioned above, in an exemplary embodiment, the rating scale has ratings from 0 to 5 wherein rating 0 is the worst rating and rating 5 is the best rating. In a similar way, the driver scores as well as the result scores may have values between 0 and 5, wherein 0 is again the worst score and 5 is the best score. The position of the driver scores and the result scores on the grid graph indicates the effectiveness of the process that is needed to be assessed. For example, if a significant number of the driver scores and the result scores are placed on the top right corner of the grid graph then the process is assessed as an efficient and effective process. On the other hand, if the significant number of the driver scores and the result scores are placed on the left bottom corner of the grid graph then the process is assessed as an ineffective and inefficient process. Therein, it is presumed that a value of 0 would be on the left side of the x-axis and on the lower end of the y-axis whereas a value of 5 would be on the right side of the x-axis and on the higher end of the y-axis.

Hence, from the position of the driver scores and the result scores on the grid graph the process may be assessed. However, the method recited here for assessing the performance of a process using grid graph is just for exemplary purposes, there are other techniques well known in the state of the art, using which the process may be assessed from the driver mean value and the result mean value calculated by the processor 110.

The processor 110 is also capable of comparing the assessment of the process for the time frame with the assessment of the process for another time frame using the comparator 114. The comparator 114 fetches the assessment of the process for the time frame from the processor 110 and the assessment of the process for the other time frame from the memory unit 112 through the processor 110. In an exemplary embodiment, the comparator 114 is directly in contact with the memory unit 112 and fetches the assessment of the process for the other time frame from the memory unit 112 directly. Further, the processor 110 is capable of displaying a lag or a lead between the assessment of the process for the time frame and the assessment of the process for the other time frame on the display 118.

The memory unit 112 of the system 100 is in connection with the processor 110, the first evaluation unit 106 and the second evaluation unit 108 as depicted in FIG. 1. The memory unit 112 stores all the processes of the organization, process drivers for all the processes, business results of the organization and an assessment history for all the organizational processes.

FIG. 2 depicts a flowchart for an embodiment of a method for assessing performance of a process.

At act 202, for example upon an input of an identifier of the process to be assessed, one or more process drivers of the process that needs to be assessed are identified by the first identification module 102 depicted in FIG. 1. Methods for identifying the one or more process drivers are provided in FIG. 1.

At act 204 of the flowchart depicted in FIG. 2, again for example upon an input of an identifier of the process to be assessed, one or more business results of the process are identified by the second identification module 104 depicted in FIG. 1. The methods for identifying the one or more business results are provided in FIG. 1.

At act 206, one or more driver scores are determined by the first evaluation unit 106 depicted in FIG. 1. The methods for determining the one or more driver scores are provided in FIG. 1.

At act 208, one or more result scores are determined by the second evaluation unit 108 depicted in FIG. 1. The methods for determining the one or more result scores are provided in FIG. 1.

At act 210, the process is assessed by using the one or more driver scores and the one or more result scores by the processor 110 depicted in FIG. 1. In one embodiment, the assessment of the process includes the plotting of the one or more driver scores and of the one or more result scores on a graph by the processor 110, for example using the graph plotter 116 as depicted in FIG. 1. In another, alternative or additional embodiment, the assessment alternatively includes calculating a driver mean value from the one or more driver scores and a result mean value the one or more result scores by the processor 110. The assessment of the process further includes displaying the driver mean value and the result mean value calculated by the processor 110 on the display 118 depicted in FIG. 1.

As will be evident from the foregoing description, the embodiments provide systems and methods for assessing performance of a process using process drivers of the process and business results achieved by the process.

The disclosed methods and systems provide for assessing a process individually by using the process drivers of the process that needs to be assessed and the business results achieved by the process that needs to be assessed.

While the present invention has been described in detail with reference to certain embodiments, it may be appreciated that the present invention is not limited to those embodiments. In view of the present disclosure, many modifications and variations would present themselves, to those of skill in the art without departing from the scope of various embodiments of the present invention, as described herein. The scope of the present invention is, therefore, indicated by the following claims rather than by the foregoing description. All changes, modifications, and variations coming within the meaning and range of equivalency of the claims are to be considered within their scope.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for assessing a performance of a process during a time frame, the method comprising:
identifying one or more process drivers related to the process for the time frame;
identifying one or more business results related to the process for the time frame;
determining one or more driver scores for the identified one or more process drivers related to the process based on a rating scale;
determining one or more result scores for the identified one or more business results related to the process based on a comparison of the one or more business results with one or more targets corresponding to the business results; and
assessing the process for the time frame based on the one or more driver scores and one or more result scores.

2. The method according to claim 1, wherein the rating scale is predefined for the time frame.

3. The method according to claim 2, wherein the one or more targets are predefined for the time frame.

4. The method according to claim 1, wherein the one or more targets are predefined for the time frame.

5. The method according to claim 1, further comprising plotting the one or more driver scores and the one or more result scores on a graph before assessing the process for the time frame.

6. The method according to claim 1, further comprising determining a driver mean value from the one or more driver scores and a result mean value from the one or more result scores.

7. The method according to claim 1, further comprising comparing the one or more driver scores and the one or more result scores of the process with one or more driver scores and one or more result scores of the process for another time frame.

8. A system for assessing a performance of a process, the system comprising:
a first identification module for identifying one or more process drivers related to the process for a time frame;
a second identification module for identifying one or more business results related to the process for the time frame;
a first evaluation unit for determining one or more driver scores for the one or more process drivers of the process based on a rating scale;
a second evaluation unit for determining one or more result scores for the one or more business results of the process based on a comparison of the one or more business results with one or more targets corresponding to the business results; and
a processor for assessing the process for the time frame based on the one or more driver scores and one or more result scores.

9. The system according to claim 8, further comprising a memory unit for storing the rating scale and the one or more targets wherein the rating scale and the one or more targets are predefined for the time frame.

10. The system according to claim 8, further comprising a graph plotter for plotting the one or more driver scores and the one or more result scores on a graph.

11. The system according to claim 8, further comprising a comparator for comparing the one or more driver scores and the one or more result scores of the process for the time frame with one or more driver scores and one or more result scores of the process for another time frame.

12. The system according to claim 8, wherein the processor is configured to determine a driver mean value from the one or more driver scores and a result mean value from the one or more result scores for assessing the process.
